(19) United States
(12) Patent Application Publication
(10) Pub. No.: US 2021/0217262 A1
(43) Pub. Date: Jul. 15, 2021

(54) SYSTEM AND METHOD FOR ALLOWING ACCESS TO A PREMISE

(71) Applicant: Fred McGill, Atlanta, GA (US)

(72) Inventor: Fred McGill, Atlanta, GA (US)

(21) Appl. No.: 17/145,204

(22) Filed: Jan. 8, 2021

Related U.S. Application Data
(60) Provisional application No. 62/959,003, filed on Jan. 9, 2020.

(51) Int. Cl. G07C 9/25; G06Q 50/16; G07C 9/00; G07C 9/27

(52) U.S. Cl. CPC G07C 9/257; G06Q 50/167; G07C 2009/00936; G07C 9/27; G07C 9/00896; G07C 9/00563

(57) ABSTRACT

A system for providing access to a premise. The system includes a lockbox or locking mechanism located at a premise and configured to aid in allowing access to the premise when provided with a manual or electronic code. The system also includes a computer server configured to communicate over a communications network, the server configured to receive a request from a buyer for access to a premise, the server further configured to send the request to a seller party for approval, the server further configured to provide a code to the buyer upon the approval.

### REFERENCE TO RELATED APPLICATIONS

This application claims priority to U.S. Provisional Patent Application No. 62/959,003, filed on Jan. 9, 2020, entitled SYSTEM AND METHOD FOR ALLOWING ACCESS TO A PREMISE, to Inventor Fred McGill, the entirety of which is herein incorporated by reference.

### BACKGROUND

Conventionally, for Home Buyers, gaining access to a premise, such as a home, that is being offered for sale is currently a cumbersome, inefficient, and costly process. According to conventional methods, when prospective buyers find a home that they would like to view or tour, the buyer is typically required to either contact the seller directly (if listed as For Sale By Owner), contact the listing real estate agent, or hire a buyer side real estate agent. One of these individuals typically then meets with the prospective buyer at the home to be viewed to physically unlock the door of the home and provide the prospective buyer access inside the property.

The conventional process of coordinating schedules between the agent, the home buyers and the property owner are inefficient, time-consuming, and often delayed accommodating conflicting schedules and associated demands. The process lacks automation and is a very inconvenient experience for the home buyer. It also requires back-and-forth coordination of details between all of the different parties involved in the process. As such, the sellers can potentially miss the opportunity to show their home to an interested buyer if they or an agent are unable to accommodate the buyer's schedule, or if there is a drop in communication anywhere along the process.

Electronic lockboxes with restricted access exist for realtors, but their use is limited to realtors who are active in a specific realtor association and pay dues to receive their “e-key”. These digital lockboxes are not available to consumers.

### SUMMARY

An exemplary embodiment relates to a system for providing access to a premise. The system includes a lockbox or locking mechanism located at a premise and configured to aid in allowing access to the premise when provided with a manual or electronic code. The system also includes a computer server configured to communicate over a communications network, the server configured to receive a request from a buyer for access to a premise, the server further configured to send the request to a seller party for approval, the server further configured to provide a code to the buyer upon the approval.

Another exemplary embodiment relates to a system for providing access to a premise. The system includes a lockbox or locking mechanism located at a premise and configured to aid in allowing access to the premise when provided with a manual or electronic code. The system also includes a processing device associated with a buyer, the processing device configured to provide an interface for communicating with a server, the interface configured to receive a property that the buyer wishes to tour in person, the interface configured to provide a request to the seller relating to the day and time the buyer wants to access the premise, the interface further configured to receive a confirmation for the day and time and the interface further configured to provide the code to the buyer or to the processing device of the buyer.

Yet another exemplary embodiment relates to a method of providing access to a premise. The method includes verifying identity of a buyer and receiving, from the buyer by a server, a request for a day and time to see a premise, sending the request to the selling party. The method also includes approving the request by the selling party and sending a code for a lockbox coupled to the premise, to the buyer.

Other exemplary embodiments relate to methods in which the buyer is enabled to give feedback to the selling party, and/or ask questions about the property, receive contact information for the seller's agent, and potentially make an offer to purchase the property.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an illustrative embodiment of a system in accordance with various examples.

FIG. 2 is an illustrative embodiment of a process in accordance with various examples.

The use of the same symbols in different drawings typically indicates similar or identical items unless context dictates otherwise.

### DETAILED DESCRIPTION

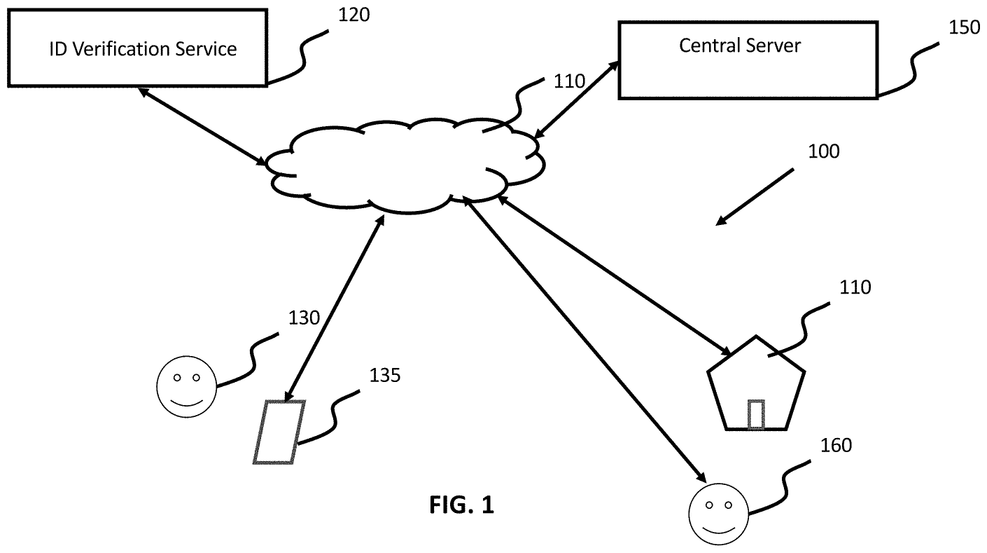

Referring now to FIG. 1, a system 100 of gaining access to a premise, such as but not limited to a house 110, is configured to eliminates the hassle and inconvenience of waiting for real estate or sales agents and coordinating schedules, while concomitantly adding a layer of safety to the home showing process. Using identity verification services 120, prospective buyers 130 are screened and verified using their mobile device 135 (alternatively any communication device including but not limited to desktop computers, over a communications network 110 (including but not limited to cellular phone networks and the internet). Once verified, the buyers 130 are sent a code from a server 150 to mobile computing device 135, such as a smartphone, which allows the buyer direct access to the home, without needing an agent. The sellers and/or seller's real estate agent (i.e., selling party)l60 determine if they want to grant instant access (for example, when a home is vacant) or if they prefer to approve/reject showing requests on a case-by-case basis.

Illustrative embodiments leverage a combination of ID verification; an integrated, digital lockbox; an SMS/text communication system; and suitable software application for use with the mobile device. While different stand-alone systems currently exist for each of these aspects individually, the system, such as system 100 provides for a comprehensive, integrated approach and application in the residential real estate space.

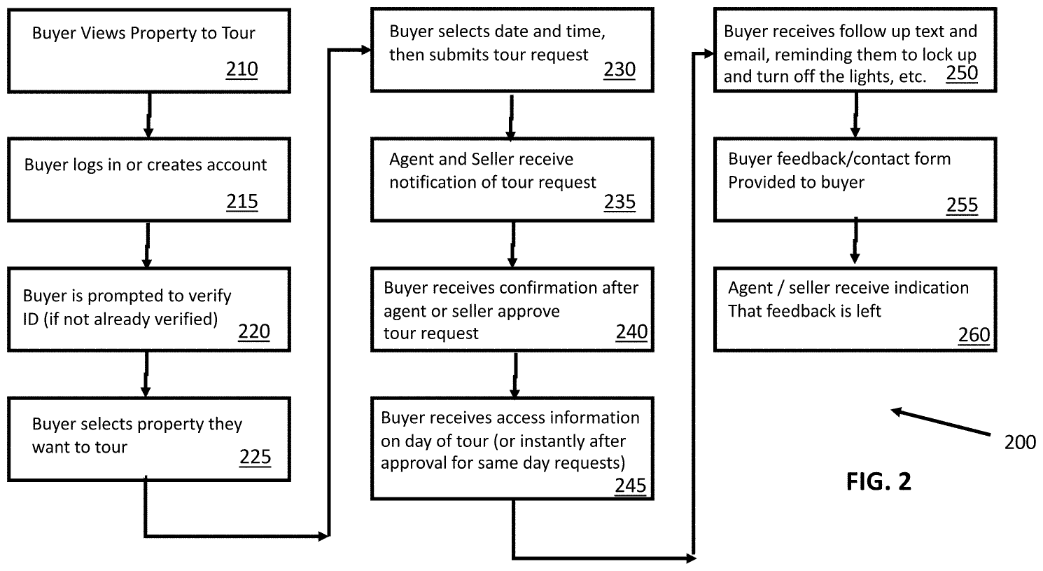

Referring now to FIG. 2, a process 200 is depicted in which a buyer may views various homes online or while driving through a neighborhood, etc. The Buyer selects a property from the one or more properties that they wish to tour (Process 210). The buyer logs into or creates an account on a website, app, or the like of the access system (process 215). The App or website requires that the buyer verifies his or her IDs, which may be done through an automated online process (process 220). In some instances, the ID verification may have been done in advance and thus is not carried out at this point. Once logged in and verified, a buyer may select the property they wish to tour (Process 225) The buyer selects a date and time that they would like to see the property (Process 230). A request (e.g., via text/SMS or the like) is sent to the seller and seller's real estate agent, alerting them to the requested showing, along with details regarding the day and time (Process 235). The seller and/or agent may then approve the requested showing or suggest another time (a system feature can also be enabled that instantly approves the request for verified buyers, bypassing the need for selling party approval for verified buyers and potentially allowing instant access, which can be particularly helpful with vacant homes) and informs the buyer with a confirmation upon approval by the seller or by the system (Process 240). The buyer then receives access information on the day of the tour (or instantly after approval for same day requests (Process 245). The information may be a pin code or a lock code or a software code which may allow a mobile device such as but not limited to the buyer's mobile phone to cause a lock box or lock to open. The buyer may receive follow-up texts or messages to the mobile device prompting them to lock up or turn off lights, etc. (Process 250). In some variations, the buyer is provided with a feedback form or contact information form for the seller or seller's agent (Process 255). The agent or seller receives an indication that feedback is left and/or that a buyer has questions about the property or is interested in making an offer. The feedback may be free form or questions from the selling party about their interest or thoughts about the property. Also, the feedback may include contact information for a sales agent.(Process 260).

According to various embodiments, system 100 may employ IglooHome lockboxes, though other companies and products may be used in the future to allow additional functionality including, but not limited to, Bluetooth capabilities, biometric information, cellular capabilities, etc. Various embodiments may be configured to send text messages to the buyer which includes an electronic access PIN that is valid for a selected or requested period of time. Other lockboxes may not require a PIN at all, but could require an electronic code for transmitting to the lock boxes.

With some Identification Verification Services, the Buyer is prompted to take a picture of an associated ID, such as a driver's license. The ID is analyzed by a third-party provider who confirms whether the ID is valid. Next, the method of the invention prompts the buyer to take a selfie photo with the mobile device (or whatever electronic device the buyer is using to interface with the system including but not limited to tablet, notebook computer, desktop computer, etc.), which is matched against the picture on the ID, to confirm and verify that the provided ID matches the buyer. Because buyers must submit an authentic ID, and the ID is verified as real and belonging to the buyer, there is a strong deterrent to theft or vandalism during the showing.

Such commercially available services include but may not be limited to Berbix or NetVerify service of Jumio, as a software plug in for the Identify Verification components listed above. Further, the system may also search third -party databases to perform a background check as part of the process.

In accordance with various embodiments, once approved, the buyer is sent a code to access the home via an integrated, digital lockbox. The buyer's access is thus limited and only valid during the requested time period. In various embodiments, adjustments may be enabled to be made to the time period to accommodate expected or anticipated time delays, and to allow for early/late arrival. No agent or back and forth coordination is needed. The entire process takes only a few minute and, in many cases, allows the buyer to access the home instantly.

In accordance with various embodiments, buyers may be enabled to either upload a pre-approval letter from a lender or be pre-approved through a qualified or certified mortgage partner. If the sellers enable this added requirement in order for the buyers to view the home, the extra step may reduce the number of showings they receive, but it also gives the sellers more confidence that only serious buyers (those who have taken the time and effort to work with a lender and get pre-approved) are seeking to view the home. The sellers can also restrict access to their home to only buyers who have been pre-approved by a lender to purchase a home in their price point. For example, if the Seller's home is listed for sale at $500,000, they can only approve showings for buyers who were pre-qualified to purchase a $500,000 home. This added lender-qualification step reduces frustration many sellers have with potential buyers who are not serious about buying their house or from under-qualified buyers who cannot afford to buy their house—both of which waste time scheduling showings.

Various embodiments thus make it easy for prospective buyers to see and tour a home that they are interested in buying—without the hassle or headache of waiting for an agent or scheduling a time when an agent is able to meet them to give them access. Indeed, many homes can be seen instantly, as soon as the buyer has been verified. The ability to offer instant or on-demand access provides convenience as well as time-savings for buyers, sellers and agents.

Various embodiments may include an associated website and/or mobile application, and texting features enable quick and convenient communication of showing requests between the buyer and seller. The buyers do not have to find an agent to show them the home, nor do they have to wait for an agent to confirm with the seller that a certain day or time works—they can do it instantly from their computer or mobile device. By eliminating the agent as the middleman for coordinating these details, showings are confirmed quicker (many instantly). The sellers also do not have to worry about missing potential showings because they or an agent weren't able to accommodate the buyer's schedule/request—or due to a drop in communication in the Buyer-agent-agent-Seller chain. Furthermore, many buyers feel more comfortable looking at their own pace, without an agent trying to “sell” them on the home.

In various embodiments, verifying the ID of prospective buyers, adds a layer of safety to the showings, which can be further strengthened with a potential background screening prior to submitting a showing request. In addition, the ability for sellers to restrict access to only buyers who have been pre-approved by a lender (or who have been pre-approved to buy a home in the price range their home is listed for sale), saves sellers from showing homes to buyers who are not serious enough about buying a home to have been pre-approved yet or who don't have the financial resources to buy a home in their price range.

In many instances, by applying the systems described herein, financial efficiency may be achieved. The seller may negotiate with their agent to reduce or eliminate the buyer agent commission (typically 2.5% to 3% of the purchase price) if the buyer accesses the home directly through this system and thus a separate buyer agent is not involved. These savings could be realized by the seller or potentially shared with the buyer.

An advantage to the system for accessing a premise is that the system may be integrated with a property listing service such as but not limited to a Multiple Listing Service (MLS). For example, a user may search properties on a MLS and upon finding a property of interest, the user may schedule and gain access to the property using the integrated system.

In accordance with other various embodiments, the system may be integrated with an agent's (or other entity's) property listings which may pull information from an MLS property listing service. For example, a user may search properties on an agent's website which pulls listings from an MLS, and upon finding a property of interest, the user may schedule and gain access to the property using the integrated system.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A system for providing access to a premise, comprising:
a lockbox or locking mechanism located at a premise and configured to aid in allowing access to the premise when provided with a manual or electronic code; and
a computer server configured to communicate over a communications network, the server configured to receive a request from a buyer for access to a premise, the server further configured to send the request to a seller party for approval, the server further configured to provide a code to the buyer upon the approval.

2. The system of claim 1, wherein the lockbox includes at least one of a keypad for entering a code, and a physical key.

3. The system of claim 1, wherein locking mechanism includes an electronic door lock.

4. The system of claim 1, wherein the computer server is further configured to connect the buyer to an identification Verification Service.

4. The system of claim 4, wherein the Identification Verification requires the buyer to provide at least one of a picture of themselves and a picture of an identification document and send the picture to the Identification Verification Service.

6. The system of claim 1, wherein the request from the buyer includes a time and date.

7. The system of claim 1, wherein the code is provided to the buyer on the day of the access.

8. The system of claim 1, wherein the server is further configured to provide a feedback request to the buyer for providing feedback about the property.

9. The system of claim 8, wherein the server is further core ed to receive the feedback from the buyer and send the feedback to the seller party.

10. The system of claim 1, wherein the seller party includes at least one of a seller and a real estate agent.

11. The system of claim 1, wherein the server is further configured to substantially instantaneously approve requests from verified buyers if such feature is enabled for the property, without requiring the selling party to specifically approve each showing request, as in the case of a vacant home.

12. A system for providing access to a premise, comprising:
a lockbox or locking mechanism located at a premise and configured to aid in allowing access to the premise when provided with a manual or electronic code; and
a processing device associated with a buyer, the processing device configured to provide an interface for communicating with a server, the interface configured to receive a property that the buyer wishes to tour in person, the interface configured to provide a request to a seller party relating to the day and time the buyer wants to access the premise, the interface further configured to receive a confirmation for the day and time and the interface further configured to provide the code to the buyer or to the processing device of the buyer.

13. The system of claim 12, wherein the lockboxincludes at least one of a keypad for entering a code, and a physical key.

14. The system of claim 12, wherein locking mechanist includes an electronic door lock.

15. The system of claim 12, wherein the server is further configured to connect the buyer to an Identification Verification Service.

15. The system of claim 15, wherein the Identification Verification requires the buyer to take a picture of at least one of themselves and of an identification document and send the picture to the Identification Verification Service.

17. The system of claim 12, wherein the request from the buyer includes a time and date.

18. The system of claim 12, wherein the code is provided to the buyer on the day of the access.

19. The system of claim 12, wherein the server is further configured to provide a feedback request to the buyer for providing feedback about the property.

20. A method of providing access to a premise, comprising:
verifying identity of a buyer;
receiving, from the buyer by a server, a request for a day and time to see a premise;
sending the request to the selling party;
approving the request by the selling party; and
sending an electronic or manual code for a lockbox or locking mechanism coupled to the premise, to the buyer.
